(19) United States
(12) Patent Application Publication
(10) Pub. No.: US 2008/0162669 A1
(43) Pub. Date: Jul. 3, 2008

(54) REPRODUCING APPARATUS AND CONTROL METHOD OF REPRODUCING APPARATUS

(75) Inventors: Akihisa Tonoike, Saitama (JP); Kojiro Matsuyama, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/953,332

(22) Filed: Dec. 10, 2007

(30) Foreign Application Priority Data
Dec. 29, 2006 (JP) 2006-356682

(51) Int. Cl. G06F 15/16

(52) U.S. Cl. 709/219

(57) ABSTRACT

A reproducing apparatus which receives contents from a server over a network and reproduced the contents is disclosed. The reproducing apparatus includes: a server access part configured to make access to a route folder of the server; a folder attribute acquiring part configured to acquire a folder attribute added to each of member folders of the route folder from the server after making access; a determining part configured to determine whether the folder containing the content of a target for acquisition exists, based on the folder attribute acquired by means of the folder attribute acquiring part; and a hierarchy display part configured to only display a hierarchy of the folder that contains the content of the target for acquisition determined by means of the determining part.

### CROSS REFERENCES TO RELATED APPLICATIONS

The present invention contains subject matter related to Japanese Patent Application JP 2006-356682 filed in the Japanese Patent Office on Dec. 29, 2006, the entire contents of which being incorporated herein by reference.

### BACKGROUND OF THE INVENTION

1. Field of the Invention

The present invention relates to a reproducing apparatus and a control method of a reproducing apparatus, particularly to a reproducing apparatus which receives contents from a server over a network and reproduces the contents, and a control method of the same.

2. Description of the Related Art

In recent years, audio contents and video contents of digitized data are widely distributed, and devices that readily record and reproduce these contents are also generally available. In addition, in order to facilitate the manipulations of these devices, there is a wide range of functions of reproduction, recording and editing, which are added to the devices (for example, see Patent Reference 1 (JP-A-2006-196058)).

With the development of network technology, a network system such as a LAN (Local Area Net work) and a wireless LAN can be readily created even in a home.

It is desired to easily exchange digital contents between devices in the home network system. To this end, protocols for the connection between devices and for content control are being standardized. As a typical example of the standards, the UPnP (Universal Plug & Play) standards announced by Microsoft Corp. (U.S.) are widely known. In addition, the DLNA (Digital Living Network Alliance) guideline based on the UPnP standards are planned, and devices compliant to the DLNA guideline are now being developed.

In the UPnP standards, UPnP devices are categorized into three groups: a media server that provides contents; a control point that functions as a control terminal device; and a client device (Media Renderer) that functions as a reproducing apparatus. Moreover, the function of the control point may be mounted on the media server or on the client device.

Then, the communication protocol is defined between these functions to facilitate the search of UPnP devices on the network and control such as reproduction operation. For example, this control protocol is used to allow one media renderer to control sending/receiving content data from a media server as well as to allow the media renderer to control the transmission of content data to another media renderer.

### SUMMARY OF THE INVENTION

In the case in which an electronic device used as a media server is configured of a personal computer, for example, there are a plurality of categories of content data and a large number of items of data other than content data. Therefore, it is necessary for a user to know the place of a folder in which audio contents are stored in advance, in order to fetch a desired item of content data from a plurality of items of data. Particularly, in the case in which a connection is made to a media server for the first time, it is really difficult to find a desired content.

It is desirable to provide a reproducing apparatus which allows a user to readily fetch contents, and a control method of a reproducing apparatus.

A reproducing apparatus according to an embodiment of the invention is a reproducing apparatus which receives a content from a server over a network, the reproducing apparatus including: a server access part configured to make access to a route folder of the server; a folder attribute acquiring part configured to acquire a folder attribute added to each of member folders of the route folder from the server after making access; a determining part configured to determine whether the folder containing the content of a target for acquisition exists, based on the folder attribute acquired by means of the folder attribute acquiring part; and a hierarchy display part configured to only display a hierarchy of the folder that contains the content of the target for acquisition determined by means of the determining part.

According to the reproducing apparatus, after the server access part makes access to the route folder of the server, the folder attribute acquiring part acquires a folder attribute. Then, the determining part determines whether the folder containing the content of a target for acquisition exists, based on the acquired folder attribute. The hierarchy display part only displays the hierarchy of the folder that contains the content of the target for acquisition determined by the determining part.

### BRIEF DESCRIPTION OF THE DRAWINGS

FIG. 1 shows a diagram depicting an exemplary configuration of a network system according to an embodiment of the invention;

FIG. 2 shows a diagram illustrative of the UPnP protocol stack (the structure of a protocol group);

FIG. 3 shows a diagram depicting an exemplary tree structure that manages the contents stored in the media server;

FIG. 4 shows a block diagram depicting the hardware configuration of a server apparatus;

FIG. 5 shows a block diagram depicting the hardware configuration of an audio reproducing apparatus;

FIG. 6 shows a block diagram depicting the software configuration of the server apparatus;

FIG. 7 shows a diagram depicting exemplary hierarchical data stored in a data storage part;

FIG. 8 shows a block diagram depicting the software configuration of the audio reproducing apparatus;

FIG. 9 shows a flow chart depicting content reproducing operation; and

FIG. 10 shows a diagram depicting an exemplary screen displayed on a monitor.

### DETAILED DESCRIPTION OF THE INVENTION

Hereinafter, an embodiment of the invention will be described in detail with reference to the drawings. In the discussion below, as an example, it is considered that an embodiment of the invention is adapted to a LAN system (network system) to be created in a home. In addition, as exemplary content data to be sent and received over the LAN system, audio data is adapted.

### 1. The Configuration of a Home Network

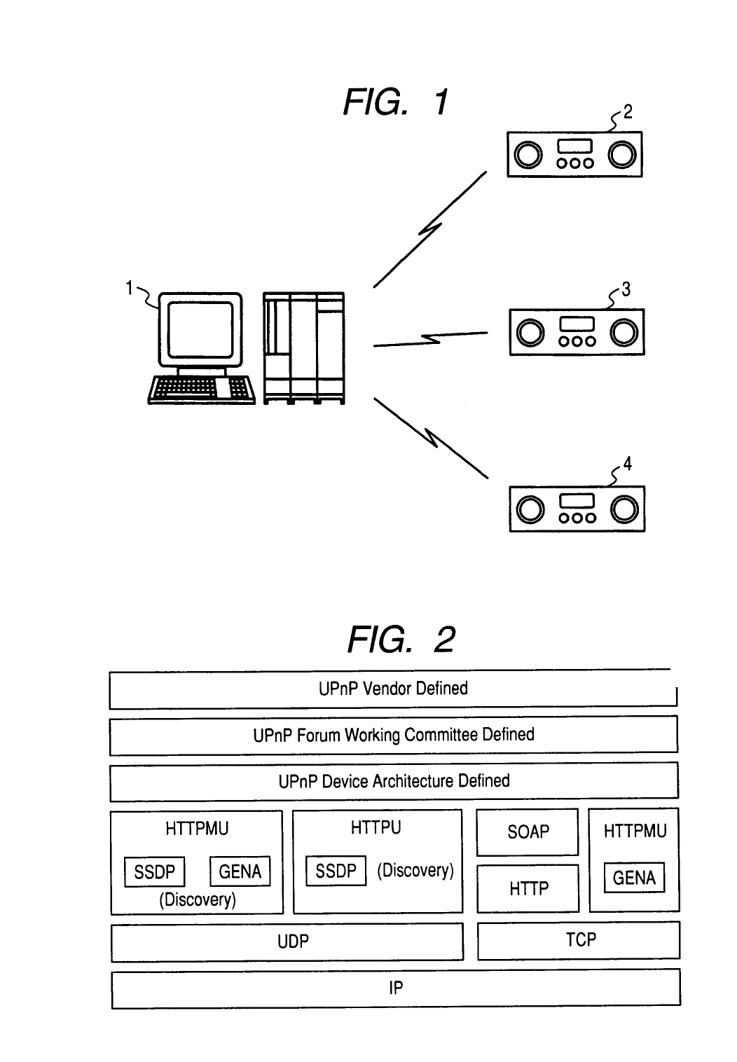

FIG. 1 shows a diagram depicting an exemplary configuration of a network system according to an embodiment of the invention.

The network system shown in FIG. 1 is configured in which a server apparatus 1 is connected to audio reproducing apparatuses 2 to 4 over a wireless LAN.

For example, the server apparatus 1 is an information processing apparatus such as a personal computer and an audio content recorder, having a function of connecting to the wireless LAN as well as a large capacity recording medium such as a HDD (Hard Disk Drive). Then, the server apparatus 1 can provide audio data stored in the HDD to the audio reproducing apparatuses 2 to 4 over the wireless LAN. The audio reproducing apparatuses 2 to 4 each have the function of connecting to the wireless LAN, each of which receives and reproduces audio data sent from the server apparatus 1 over the wireless LAN.

Moreover, in the network system, actually, for example, the server apparatus 1 and the audio reproducing apparatuses 2 to 4 are connected to a broadband rooter, not shown, to create the LAN system. In this case, the broadband rooter has the DHCP (Dynamic Host Configuration Protocol) server function and the NAT (Network Address Translation) function for devices on the wireless LAN, whereby the individual devices on the wireless LAN are allowed to share lines on the external network (WAN: Wide Area Network) side.

In the network system thus configured, the server apparatus 1 has a function as an information providing apparatus that provides audio data, and the audio reproducing apparatuses 2 to 4 have a function as a client device (information reproducing apparatus) that receives audio data from the server apparatus 1 and reproduces the audio data. Then, a user is allowed to enjoy different audio contents offered by the server apparatus 1 through each of the audio reproducing apparatuses 2 to 4. In other words, the audio reproducing apparatuses 2 to 4 can select any one of server apparatuses 1 as a distribution source depending on audio data (an audio content) to be reproduced.

Furthermore, it is supposed that the audio reproducing apparatuses 2 to 4 according to the embodiment are devices compliant to the guideline recommended by the DLNA (Digital Living Network Alliance) as an example, in order to facilitate connections between electronic devices and to readily exchange content data. In the DLNA guideline, for the protocols of the detection and control of electronic devices and the management of content data, it is requested to meet UPnP (Universal Plug & Play) announced by Microsoft Corp. (U.S.) as standards.

UPnP is the specifications for a protocol group configured of IP (Internet Protocol) and TCP (Transmission Control Protocol) and UDP (User Datagram Protocol) on IP and data formats that can be used on a typical IEEE (Institute of Electrical and Electronic Engineers) 802 network in network communications using 10/100 BASE-T Ethernet (Ethernet (trademark)), and UPnP expands the functions of the Internet standard communications (TCP/IP communications).

Then, the adoption of UPnP to so-called CE (Consumer Electronics) devices such as an audio reproducing apparatus allows a CE device such as an audio reproducing apparatus to readily authenticate another CE device or a personal computer to each other and to offer services over a network or to do a service offered simply and properly, with no troublesome work on a user.

### 2. The Outline of UPnP

FIG. 2 shows a diagram illustrative of the UPnP protocol stack (the structure of the protocol group).

As shown in FIG. 2, in UPnP, actual data transmission/reception is conducted in accordance with the Internet standard communication protocol. In addition, in order to implement UPnP's unique functions as described below, the protocol group of SSDP (Simple Service Discovery Protocol), GENA (General Event Notification Architecture), SOAP (Simple Object Access Protocol), and HTTP (HyperText Transfer Protocol) is used.

Furthermore, in UPnP, as shown in FIG. 2, the following definitions are made: UPnP Vendor Defined, UPnP Forum Working Committee Defined, and UPnP Device Architecture Defined.

Then, UPnP offers six functions: Addressing, Discovery, Description, Control, Eventing, and Presentation. Hereinafter, six functions offered by UPnP will be described.

In order to utilize audio data using the UPnP functions, a UPnP device such as an audio reproducing apparatus (an electronic device mounted with UPnP) complies with the specification, UPnP audio visual architecture. UPnP devices in the UPnP audio visual architecture are categorized into three types as below.

In other words, in the UPnP audio visual architecture, the UPnP devices are categorized into three groups: a media server that provides contents; a control point that functions as a control terminal device; and a media renderer that functions as a reproducing apparatus. Here, the media server corresponds to a device generally referred as a server apparatus in the network system, and the media renderer corresponds to a device generally referred as a client device in the network system.

In addition, the control point (control unit) is a device that can control the individual UPnP devices connected to the network. The function as the control point may be mounted on both of the media server and the media renderer. The control point may be mounted on all the electronic devices configuring the network, and the control point may be mounted on a given electronic device configuring the network. In the embodiment, as an example, it is supposed that each of the server apparatuses 1 is mounted with the function as the control point.

In addition, the function Addressing in UPnP is the function that a UPnP device acquires an address to identify itself over an IEEE 802 network using DHCP or Auto-IP.

The function Discovery is performed after addressing, whereby the control point can discover a target device desired to control (a media server or a media renderer). The protocol used here is SSDP described above. The electronic devices configuring the network system each broadcast a message notifying own devices and services to the IEEE 802 network when connected to the IEEE 802 network. The control point receives the broadcast message to know what device is connected to the IEEE 802 network.

In a SSDP packet outputted from the electronic device that is a control target and discovered by the control point by means of the function discovery, a URL (Uniform Resource Locator) of device description is described. The control point makes access to the URL, and thus it can acquire more detailed device information about the electronic device from the device description.

In the device information, the service description is described on which icon information, a model name, a manufacturer name, a trade name, and detailed information about services of the device are described. The control point can know an access method to the target device from the device description and the service description. The device description and the service description are expressed in XML (eXtensible Markup Language).

The function Control is roughly categorized into two functions: Action and Query. The function Action is performed in accordance with a method specified in action information of the service description, and the control point invokes the function Action to operate the target device. The function Query is used to fetch the value of device information (State Variable) in the service description. In the function Control, the transport protocol SOAP described above is used, and XML is used for expression.

The function Eventing is used to notify the control point from the target device that the value of device information is changed when changed. In the function Eventing, the transport protocol GENA described above is used, and XML is used for expression. The function Presentation is used to provide a control unit using a user interface for a user.

The UPnP devices use the UPnP functions described above to participate in networks for communications, without requesting a user to do complicate manipulations, as well as to even automatically detect and connect to another UPnP device.

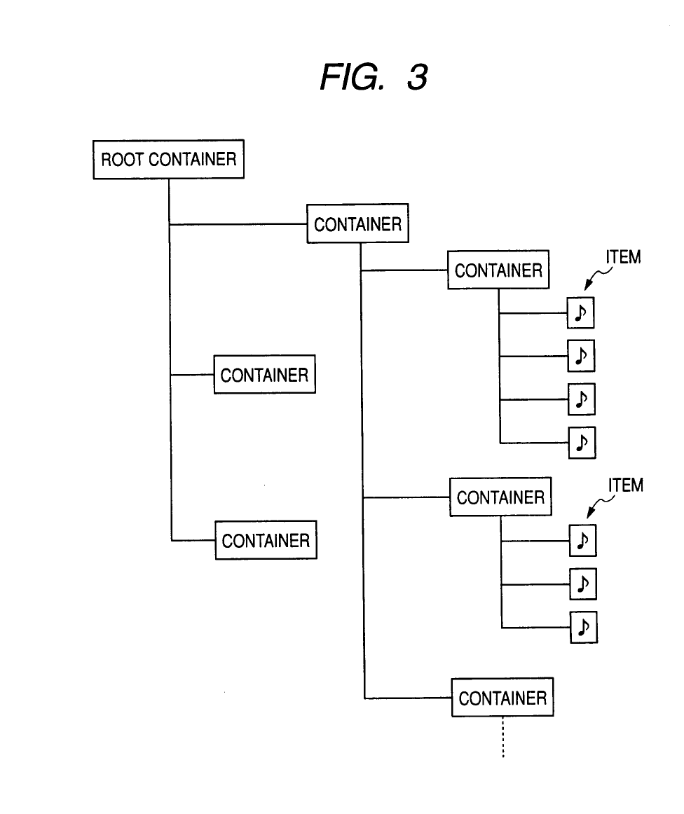

FIG. 3 shows a diagram depicting an exemplary tree structure that manages the contents stored in the media server.

In the media server that is a UPnP device, the function (Service) CDS (Contents Directory Service) is incorporated therein, and the media server uses this function to notify the control point how contents are stored in the media server. The function CDS has two abstracted objects, Container and Item (Item), and the objects correspond to a so-called folder and a file in Windows (trademark) that is an OS (Operating System) offered by Microsoft Corp. (U.S.). As shown in FIG. 3, the containers and the items form a tree structure all the time. Moreover, in the embodiment, audio contents (audio data) to be distributed mean the items in FIG. 3.

The control point acquires the tree structure shown in FIG. 3 from the media server to obtain a URL of each of contents (a link on which information is written). Then, in the case in which the control point can acquire information about a desired audio content (an item), the control point uses the function AV transport of the media server (AV Transport) to manipulate audio tracks (audio data) such as reproduction and stop of the audio content.

As discussed above, the server apparatus 1 and the audio reproducing apparatuses 2 to 4 according to the embodiment use the UPnP addressing function to turn them into the state to allow TCP/IP communications, and they use the UPnP discovery function to authenticate the devices one another. Accordingly, the individual devices know the configuration of the network to communicate with a target electronic device.

### 3. An Exemplary Configuration of the Server Apparatus

Next, an exemplary configuration of the individual electronic devices configuring the network system according to the embodiment will be described.

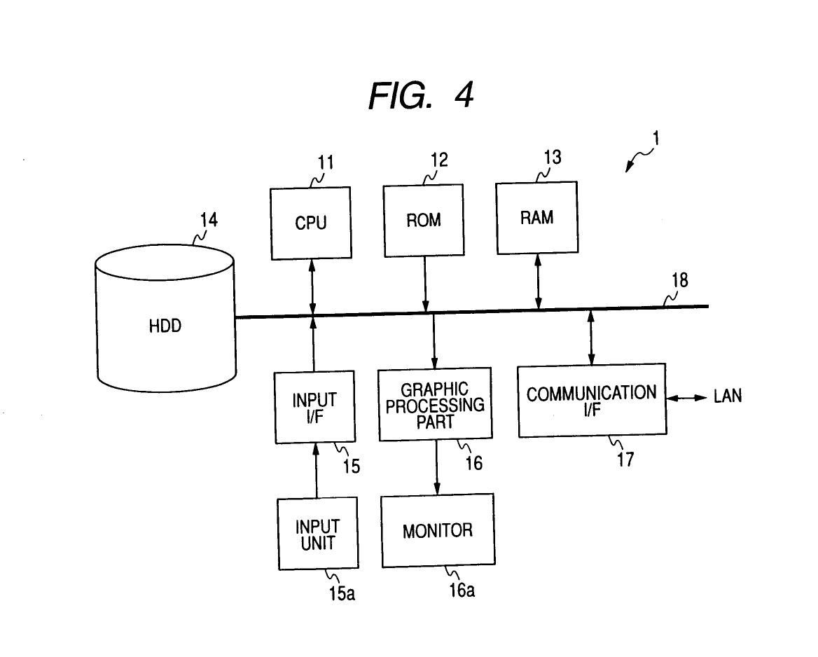

FIG. 4 shows a block diagram depicting the hardware configuration of the server apparatus.

As shown in FIG. 4, the server apparatus 1 has a CPU (Central Processing Unit) 11, a ROM (Read Only Memory) 12, a RAM (Random Access Memory) 13, a HDD 14, an input interface (I/F) 15, a graphic processing part 16, and a communication interface (I/F) 17, in which these parts are connected to one another through an internal bus 18.

The CPU 11 controls the overall server apparatus 1. The ROM 12 is recorded with programs and data necessary for processing executed in the CPU 11. The RAM 13 is mainly used as a work area in various processes.

The HDD 14 has a capacity to store a number of digital contents (information to provide). In addition, the HDD 14 holds various programs and items of data for processing executed by the CPU 11, and the HDD 14 is also used as a work area in decoding contents and in sending contents to another device over a wireless LAN.

In the embodiment, the HDD 14 stores therein a server program that allows the HDD 14 to function as a server compliant to the DLNA guideline and to send audio data to the audio reproducing apparatuses 2 to 4, and the program is executed by the CPU 11. In addition, the function of the server program may include a coding system and a sampling rate for audio data stored in the HDD 14, and a transcoding function of converting a quatization rate.

For example, to the input I/F 15, an input unit 15a such as a keyboard and a mouse is connected. The input I/F 15 sends signals from the input unit 15a to the CPU 11 through the internal bus 18.

To the graphic processing part 16, a monitor 16a such as a LCD (Liquid Crystal Display) is connected. The graphic processing part 16 displays images on the screen of the monitor 16a in accordance with an instruction from the CPU 11.

The communication I/F 17 connects to the wireless LAN for data transmission/reception with the other devices.

### 4. An Exemplary Configuration of the Audio Reproducing Apparatus

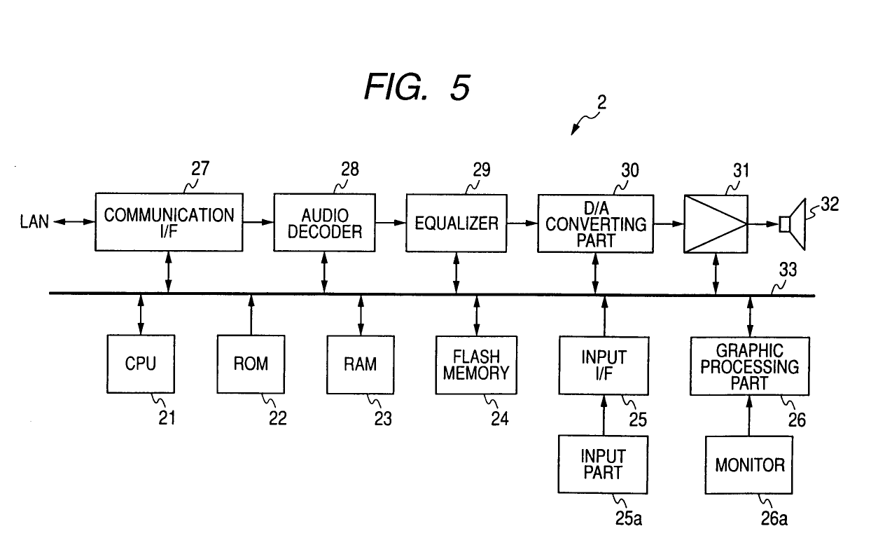

FIG. 5 shows a block diagram depicting the hardware configuration of the audio reproducing apparatus. Moreover, as an example, the configuration of the audio reproducing apparatus 2 will be described, but the audio reproducing apparatuses 3 and 4 can be also implemented by a similar hardware configuration.

As shown in FIG. 5, the audio reproducing apparatus 2 has a CPU 21, a ROM 22, a RAM 23, a flash memory 24, an input interface (I/F) 25, an input part 25a, a graphic processing part 26, a monitor 26a, a communication interface (I/F) 27, an audio decoder 28, an equalizer 29, a D/A converting part 30, an audio amplifier 31, and a speaker 32. Among them, each of the blocks except the speaker 32 is connected to one another through an internal bus 33.

The CPU 21 controls the overall audio reproducing apparatus 2. The ROM 22 is recorded with programs and data necessary for processing executed in the CPU 21. The RAM 23 is mainly used as a work area in various processes. Moreover, the CPU 21, the ROM 22, and the RAM 23 may be implemented by a microcomputer. For example, the flash memory 24 is a rewritable non-volatile memory, on which various items of data to be held is recorded even after the power source of the audio reproducing apparatus 2 is turned off.

The input I/F 25 sends signals from the input part 25a to the CPU 21 through the internal bus 33. On the input part 25a, various input switches such as manipulation keys are provided.

The graphic processing part 26 displays images on the screen of the monitor 26a in accordance with an instruction from the CPU 21. For example, the monitor 26a is configured of LCD.

The communication I/F 27 connects to the wireless LAN for data transmission/reception with the other devices. In addition, the communication I/F 27 is configured to extract encoded audio data from a packet received over the wireless LAN and to directly pass the data to the audio decoder 28.

The audio decoder 28 decodes the encoded audio data received from the communication I/F 27. For example, the audio decoder 28 can decode audio data in the compression and coding system of MP3 (Moving Picture Experts Group Audio Layer-3). In addition, the audio decoder 28 also has the function that audio data in the LPCM (Linear Pulse Code Modulation) system is received and the data is outputted to the equalizer 29 as it is.

The equalizer 29 applies sound quality adjustment to the audio data supplied from the audio decoder 28, and outputs the data to the D/A converting part 30. The parameters for sound quality adjustment are instructed to the equalizer 29 from the CPU 21 in accordance with a user instruction input accepted through the input part 25a.

The D/A converting part 30 converts the digital audio data supplied from the equalizer 29 into analog audio signals. The audio amplifier 31 amplifies the analog audio signals supplied from the D/A converting part 30 to a predetermined level, and supplies the amplified signals to the speaker 32. Thus, from the speaker 32, sounds in accordance with the analog audio signals supplied thereto are reproduced and outputted.

Moreover, the functions of the audio decoder 28 and the equalizer 29 may be implemented by software executed in the CPU 21.

With the hardware configuration described above, the processing function according to the embodiment can be implemented. In order to reproduce audio data in the network system of this hardware configuration, the server apparatus 1 and the audio reproducing apparatuses 2 to 4 have the following function therein.

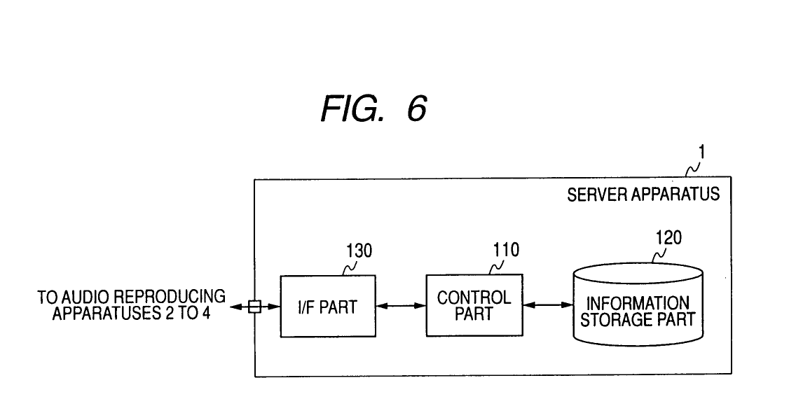

FIG. 6 shows a block diagram depicting the software configuration of the server apparatus.

The server apparatus 1 has a control part 110, an information storage part 120, and an I/F part 130.

The control part 110 receives a request from the audio reproducing apparatuses 2 to 4, and then responds thereto. For example, when it is a request from the audio reproducing apparatus 2 to acquire the hierarchical structure of the server apparatus 1, the control part 110 sends the hierarchical structure of the containers and the items stored in the information storage part 120 to the audio reproducing apparatus 2.

The information storage part 120 stores therein hierarchical data in which the contents in the server apparatus 1 are summarized in a tree structure for each type of the contents.

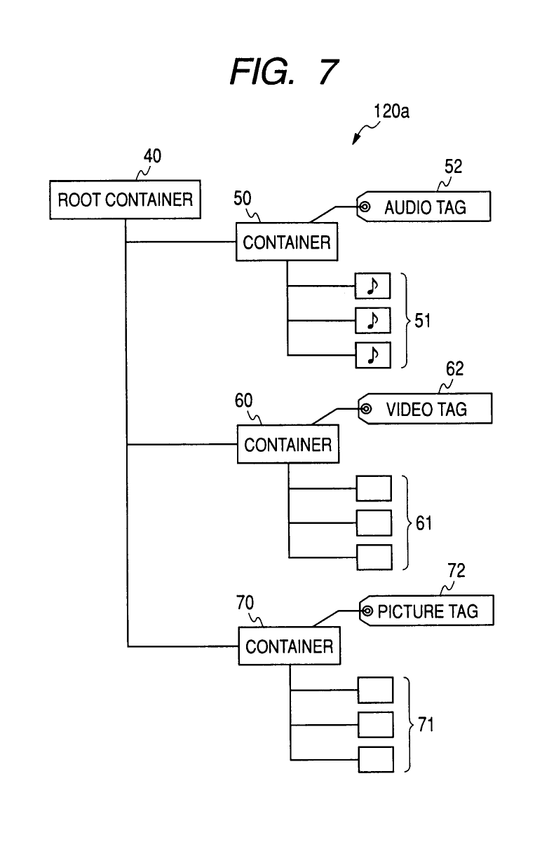

FIG. 7 shows a diagram depicting exemplary hierarchical data stored in the data storage part.

Hierarchical data 120a has a route container 40 having a unique object ID. In the sublayer of the route container 40, there are contents in different categories, and containers 50, 60 and 70 each having a unique object ID are provided. The container 50 has audio contents 51, 51 and 51. The container 60 has video contents 61, 61 and 61. The container 70 has picture contents 71, 71 and 71.

The containers 50, 60 and 70 are each added with a tag (folder attribute) showing what is inside the contents contained in the container. The container 50 is added with an audio tag 52, the container 60 is added with a video tag 62, and the container 70 is added with a picture tag 72.

In addition, the information storage part 120 also stores therein information about each of the containers and the contents. The information is not restricted particularly. For example, identification information (an object ID and a name) of members (member containers) of the parent container, information about the number of the member containers and the number of the items belonging to a single parent container, and information about data arrangement in the container (for example, the container first, then the item next) are cited.

The I/F part 130 configures an interface between the control part 110 and the audio reproducing apparatuses 2 to 4.

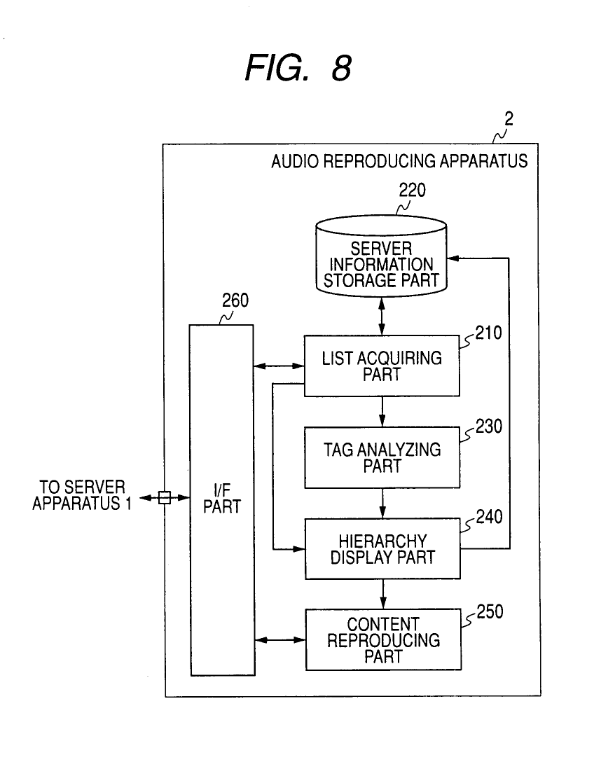

FIG. 8 shows a block diagram depicting the software configuration of the audio reproducing apparatus. Moreover, FIG. 8 typically shows the functions of the audio reproducing apparatus 2, and the audio reproducing apparatuses 3 and 4 also have the functions similar to those of the audio reproducing apparatus 2.

The audio reproducing apparatus 2 has a list acquiring part 210, a server information storage part 220, a tag analyzing part 230, a hierarchy display part 240, a content reproducing part 250, and an I/F part 260.

For example, the list acquiring part 210 makes access to the server apparatus 1 at the time when the power source of the audio reproducing apparatus 2 is turned on, and sends a request for acquiring the structure of the hierarchical data 120a (a request for acquiring the hierarchical structure) to the server apparatus 1. The list acquiring part 210 configures the main part of a server access part and a folder attribute acquiring part.

The server information storage part 220 stores therein an access flag indicating whether the audio reproducing apparatus 2 makes access to the server apparatus 1, and the object ID of the route container 40 of the server apparatus 1. Moreover, the state of the access flag may be reset at the time when the audio reproducing apparatus 2 is turned off, or may be held as it is.

The tag analyzing part 230 grasps the number and types of tags, and extracts the audio container added with the audio tag 52 and what is inside (the container and the contents). The tag analyzing part 230 configures the main part of the determining part.

The hierarchy display part 240 displays only the audio container and the contents extracted by the tag analyzing part 230 on the monitor 26a.

The content reproducing part 250 acquires the content data of a content selected by a user from the server apparatus 1 and reproduces the data.

The I/F part 260 configures an interface between the list acquiring part 210 or the content reproducing part 250 and the server apparatus 1.

Next, the operation (content reproducing operation) in which the audio reproducing apparatus 2 acquires and reproduces the contents in the network system like this will be described.

FIG. 9 shows a flow chart depicting the content reproducing operation.

First, the power source of the audio reproducing apparatus 2 is turned on, and then the list acquiring part 210 references to the access flag to determine whether it is the first time access to the server apparatus 1 (Step S11).

If it is the first time access (Yes in Step S11), the list acquiring part 210 executes the instruction Browse Direct Children for the route container 40 based on the object ID of the route container 40 stored in the server information storage part 220, and acquires a list (Step S12).

The instruction Browse Direct Children is sent to acquire the following: (1) a list (the name of the tag, and the existence and the arrangement of the container and the item (such as the item first, and the order of titles)), (2) the total numbers of the member containers and the items, (3) the object ID and the name (character string) of each of the member containers and the items, and (4) the attribute of the object.

Subsequently, the tag analyzing part 230 analyzes the tag added to each of the containers, and checks the number of the audio containers (target containers) (Step S13). Consequently, if there is no audio container, or if there are two or more of audio containers (No in Step S13), the operation is ended. On the other hand, if there is one audio container (Yes in Step S13), the object ID of the found audio container is set to a route ID (Step S14). Then, the set route ID is stored in the server information storage part 220.

On the other hand, in Step S11, if it is not the first time access (if it is the second access or later) (No in Step S11), the list acquiring part 210 performs the instruction Browse Direct Children to the audio container having the route ID stored in the server information storage part 220 by the tag analyzing part 230 in the first time access as necessary, and acquires a list (Step S15).

Subsequently, the hierarchy display part 240 displays the hierarchy of the audio container on the monitor 26a based on the acquired list (Step S16).

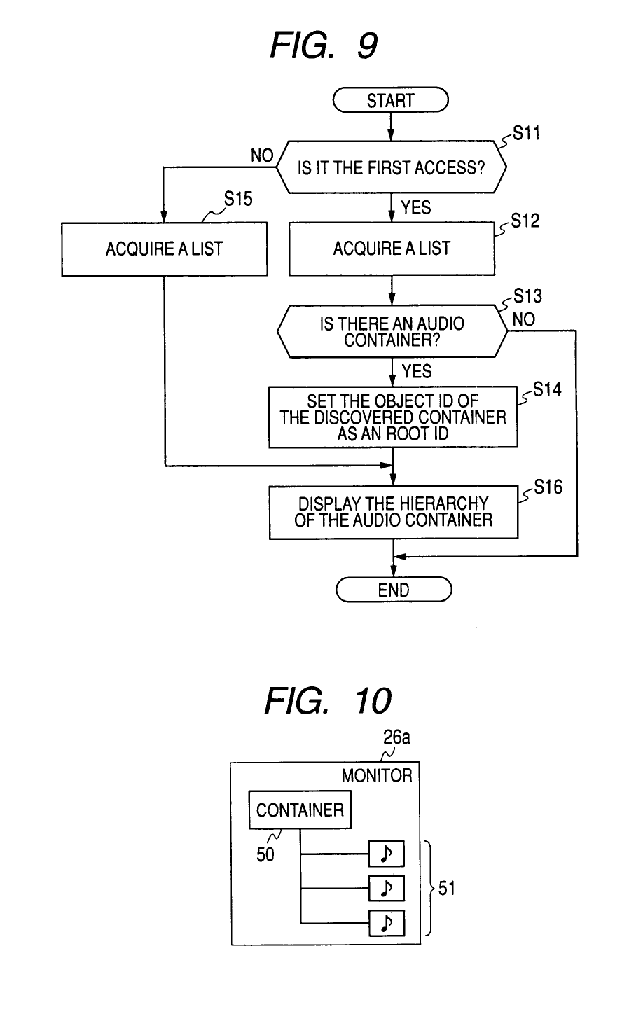

FIG. 10 shows a diagram depicting an exemplary screen displayed on the monitor.

In FIG. 10, on the monitor 26a, the route container 40 is not displayed, and the container 50 and the audio contents 51, 51 and 51 are displayed from the beginning. Then, a user selects one of the audio contents 51, 51 and 51, and then the content reproducing part 250 acquires the content data of the selected audio content 51 from the server apparatus 1, and reproduces the data.

As discussed above, in accordance with the network system according to the embodiment, in the audio reproducing apparatuses 2 to 4, all the containers opened by the server apparatus 1 are not shown, and only the container containing the audio contents is displayed on the display part 26a, whereby a user can readily perform a content search without displaying information unnecessary for the user.

In addition, the tag analyzing part 230 can make a determination based on the tag, and thus a determination can be made with no reference to what is inside in the contents to allow fast processing.

In addition, the container added with the audio tag is considered to be the route container in the subsequent access and later, and in the subsequent access and later, the list acquiring part 210 uses the route container's route ID to make access to the server apparatus 1, whereby the time to connect to the server apparatus 1 for the next time and later can be shortened.

In addition, in the embodiment, the operation is ended in the case in which the number of the audio containers is two or greater, but the embodiment of the invention is not restricted thereto. For example, all the reproducible audio containers may be displayed on the monitor 26a.

Moreover, in Step S13 discussed above, even though the number of the audio containers is two or greater, in the case in which there is one container substantially selectable (for example, regardless of the audio container substantially unselectable), such a determination may be made that the number of the audio containers is one.

In addition, for example, such a scheme may be possible that a user selects an audio container displayed on the monitor 26a, and then the hierarchy display part 240 displays the hierarchy of the selected audio container on the monitor 26a, or that in the case in which the container 50 further contains a container, a tag added to the container is checked and the container is displayed on the monitor 26a in the case in which the tag is the audio tag 52.

As discussed above, the reproducing apparatus and the control method of the reproducing apparatus according to the embodiment of the invention have been described with reference to the embodiment shown in the drawings, but the embodiment of the invention is not restricted thereto. The configurations of the individual parts can be replaced by a given configuration with the similar function. In addition, other given configurations and process steps may be added to the embodiment of the invention.

Moreover, the embodiment of the invention may be a combination of two given configurations (features) in the embodiment discussed above.

In addition, the processing functions described above can be implemented by a computer. In this case, a program is provided which describes the descriptions of the process steps of the functions that the audio reproducing apparatuses 2 to 4 should have. The program is run on a computer, whereby the processing functions can be implemented on the computer. The program that describes the descriptions of the process steps can be recorded on a computer readable recording medium. For example, for the computer readable recording medium, a magnetic recording unit, an optical disk, a magneto-optical recording medium, and a semiconductor memory are named. For the magnetic recording unit, for example, a hard disk drive (HDD), a flexible disk (FD), and a magnetic tape are named. For the optical disk, for example, a DVD (Digital Versatile Disc), a DVD-RAM (Random Access Memory), a CD-ROM (Compact Disc Read Only Memory), and a CD-R (Recordable)/RW (ReWritable) are named. For the magneto-optical recording medium, for example, a MO (Magneto-Optical disk) is named.

In the case in which the program is distributed, for example, a portable recording medium such as a DVD and a CD-ROM on which the program is recorded is sold. In addition, this scheme may be possible that the program is stored in the storage of a server computer, and the program can be forwarded from the server computer to another computer over the network.

For example, the computer that runs the reproduction program stores the program recorded on the portable recording medium or the program forwarded from the server computer in the own storage. Then, the computer reads the program out of the own storage to execute the process in accordance with the program. Moreover, the computer may directly read the program out of the portable recording medium to execute the process in accordance with the program. In addition, the computer may execute a process in accordance with the received program one after another at every time when a program is forwarded from the server computer.

In addition, in the embodiment, the case is described in which the server apparatus only has the function as the media server, but the server apparatus may further has the function as the media renderer. In this case, the server apparatus can be included as a switching source and a switching destination of a reproducing apparatus.

Furthermore, for the contents that are distributed from the media server and reproduced in the media renderer, in addition to audio contents, video contents, still image contents, and text contents such as news can be adapted.

In addition, in the embodiment, the case is described in which the embodiment of the invention is adapted to the content server system using UPnP. In addition to this, for example, the embodiment of the invention can be adapted to network systems to which various specifications such as Jini (Java (trademark) intelligent network infrastructure), and HAVi (Home Audio/Video interoperability) are adapted. In other words, the embodiment of the invention can be adapted to various network systems which have a server apparatus that provides various contents such as audio contents and an audio reproducing apparatus that receives the provided contents and reproduces the contents one another.

It should be understood by those skilled in the art that various modifications, combinations, sub-combinations and alterations may occur depending on design requirements and other factors insofar as they are within the scope of the appended claims or the equivalents thereof.

What is claimed is:

1. A reproducing apparatus which receives a content from a server over a network and reproduces the content, the reproducing apparatus comprising:
a server access part configured to make access to a route folder of the server;
a folder attribute acquiring part configured to acquire a folder attribute added to each of member folders of the route folder from the server after making access;
a determining part configured to determine whether the folder containing the content of a target for acquisition exists, based on the folder attribute acquired by means of the folder attribute acquiring part; and
a hierarchy display part configured to only display a hierarchy of the folder that contains the content of the target for acquisition determined by means of the determining part.

2. The reproducing apparatus according to claim 1,
wherein the hierarchy display part considers the folder changed to be an access destination folder,
the server access part makes access to the access destination folder with no access to the route folder in subsequent access and later, and
the hierarchy display part displays a hierarchy of the access destination folder.

3. The reproducing apparatus according to claim 2, further comprising an ID storage part configured to store therein an ID unique to the route folder in advance,
wherein the server access part makes access to the folder having the ID in a first time access,
the determining part acquires an ID unique to the folder that is determined to contain the content of a target for acquisition, and the determining part stores it as an ID for the route folder in the ID storage part, and
the server access part makes access to the folder having the ID stored by the determining part in subsequent access and later.

4. The reproducing apparatus according to claim 1,
wherein the server has a directory structure in which contents common in a category are summarized for every folder.

5. A control method of a reproducing apparatus which receives a content from a server over a network and reproduces the content, the method comprising the steps of:
making access to a route folder of the server by a server access part;
acquiring a folder attribute added to each of member folders of the route from the server by a folder attribute acquiring part after making access;
determining whether the folder containing the content of a target for acquisition exists, based on the folder attribute acquired by means of the folder attribute acquiring part by a determining part; and
displaying a hierarchy of the folder that contains the content of the target for acquisition determined by means of the determining part by a hierarchy display part.

6. The control method of a reproducing apparatus according to claim 5, further comprising the steps of:
acquiring an ID unique to the folder that is determined to contain the content of a target for acquisition by means of the determining part by an ID acquiring part, and
holding the unique ID acquired by means of the ID acquiring part by control done by a holding control part.

7. The control method of a reproducing apparatus according to claim 6,
wherein when the unique ID is held by control done by the holding control part, access is made to a folder having the held unique ID.
